(19) United States
(12) Patent Application Publication
(10) Pub. No.: US 2014/0242566 A1
(43) Pub. Date: Aug. 28, 2014

(54) TECHNIQUES FOR USE IN COMMUNICATIONS OF SYSTEMS FOR TARGETED DATACASTING

(71) Applicant: TV Band Service, LLC, Wilmington, NC (US)

(72) Inventors: Donald C. RICH, JR., Wrightsville Beach, NC (US); Paul Allan SADOWSKI, Apex, NC (US); Keith W. BOLICK, Wilmington, NC (US); John M. CHAPIN, Alexandria, VA (US)

(73) Assignee: TV Band Service, LLC, Wilmington, NC (US)

(21) Appl. No.: 14/191,122

(22) Filed: Feb. 26, 2014

Related U.S. Application Data
(60) Provisional application No. 61/770,580, filed on Feb. 28, 2013.

(51) Int. Cl. G09B 5/02

(52) U.S. Cl. CPC G09B 5/02
USPC 434/350

(57) ABSTRACT

A central server outside of a school network receives assignments from educator computing devices, where each assignment includes content for distribution to student computing devices and a schedule indicating when the assignment is active for distribution. A local server within the school network receives the assignments and stores the assignments in a local server datastore. The local server receives from a gateway within the school network a request for active assignments, identifies the active assignments, and returns a list of the active assignments to the gateway. The gateway determines whether the list of the active assignments contains any assignments unretrieved by the given gateway. If so, the gateway sends to the local server a request for the unretrieved assignments. The gateway receives the requested assignments from the local server and stores them in a gateway datastore.

### CROSS-REFERENCE TO RELATED APPLICATIONS

The present application is a non-provisional of co-pending U.S. provisional patent application Ser. No. 61/770,580, filed on Feb. 28, 2013.

The present application is related to the following U.S. patent applications: Ser. No. 13/927,856, filed on Jun. 26, 2013, which is a continuation of U.S. Pat. No. 8,503,925, filed on Feb. 2, 2011 and issued on Aug. 6, 2013; Ser. No. 13/892,344, filed on May 13, 2013; and Ser. No. 14/054,407, filed on Oct. 15, 2013, which claims priority to U.S. provisional patent application Ser. No. 61/760,799, filed on Feb. 5, 2013.

### BACKGROUND OF THE INVENTION

Many schools have networks giving educators and students access to educational content residing on the Internet. Educators are increasingly incorporating such content in their lessons. However, several stumbling blocks exist. One problem is the limitations of a school's external WAN bandwidth capacity in providing reliable and equal access to Internet content to students. For example, a teacher may share a link to a video and request that students view the video as part of a lesson. However, when the students attempt to simultaneously access the same video, not all students may be able to view the video due to limitations of the school networks bandwidth. This use of bandwidth is also inefficient as the identical content is accessed multiple times. Due to the costs involved, a school often cannot afford to increase the capacity of its network to ensure that all students may reliably access Internet content while on the school's premises.

### BRIEF SUMMARY OF THE INVENTION

According to one embodiment of the present invention, in a method for delivery of content in an educational context, a central server receives one or more assignments from the one or more educator computing devices, where each assignment comprises content for distribution from one or more educator computing devices to a plurality of student computing devices and a schedule indicating when the assignment is active for distribution. The central server may reside outside of a school network or within the school network. A local server within the school network receives the one or more assignments and stores the assignments in a local server datastore. The local server receives a request for active assignments stored in the local server datastore from a given gateway of a plurality of gateways within the school network. The local server identifies the active assignments stored in the local server datastore and returns a list of the active assignments stored in the local server datastore to the given gateway. The given gateway determines whether the list of the active assignments stored in the local server datastore contains any assignments unretrieved by the given gateway and sends a request for the unretrieved assignments stored in the local server datastore to the local server. The given gateway receives the requested assignments stored in the local server datastore from the local server and stores the requested assignments from the local server datastore in a given gateway datastore.

In one aspect of the present invention, further in the method, a given student computing device within the school network connects to the given gateway and sends to the given gateway a request for active assignments stored at the given gateway datastore. The given gateway identifies the active assignments stored in the given gateway datastore and returns a list of the active assignments stored in the given gateway datastore to the given student computing device. The given student computing device determines whether the list of the active assignments stored in the given gateway datastore contains any assignments unretrieved by the given student computing device and sends to the given gateway a request for the unretrieved assignments stored in the given gateway datastore. The given student computing device receives the requested assignments stored in the given gateway datastore from the given gateway and stores the requested assignments from the given gateway datastore in a given student computing device datastore.

In one aspect of the present invention, the list of the active assignments stored in the given gateway datastore comprises metadata for each active assignment. In sending the request for unretrieved assignments to the given gateway, the given student computing device compares the metadata for each unretrieved assignment with parameters stored at the given student computing device, and sends to the given gateway the request for the unretrieved assignments stored in the given gateway datastore with metadata matching the parameters.

In one aspect of the present invention, further in the method, the given gateway extracts a message comprising a given requested assignment and a first targeter, wherein the given gateway comprises a second targeter, wherein each targeter comprises one or more selectors associated with an action ID and one or more key value pairs. The given gateway determines whether one or more conditions for a given selector are met for one or more values of the key value pairs, and in response to determining that the one or more conditions for the given selector are met, performing an action identified by the action ID associated with the given selector.

In one aspect of the present invention, the given gateway, using one or more values of the key value pairs of the second targeter, determines whether one or more conditions of a given selector of the first targeter are met. In response to determining that the one or more conditions of the given selector of the first targeter are met, the given gateway performs an action for the action ID associated with the given selector of the first targeter.

In one aspect of the present invention, the given gateway, using one or more values of the key value pairs of the first targeter, determines whether one or more conditions of a given selector of the second targeter are met. In response to determining that the one or more conditions of the given selector of the second targeter are met, the given gateway performing an action for the action ID associated with the given selector of the second targeter.

In one aspect of the present invention, each requested assignment comprises associated targeter data attributes, and further in the method, the given gateway selects one or more of the requested assignments from the local server for storage in the given gateway datastore based on the targeter data attributes associated with each requested assignment from the local server. The given gateway receives a message request from a receiver device within the school network, and in response to the message request, sends one or more assignments in the given gateway datastore to the receiver device.

System and computer program products corresponding to the above-summarized methods are also described and claimed herein.

### BRIEF DESCRIPTION OF THE SEVERAL VIEWS OF THE FIGURES

FIG. 1 is a functional block diagram illustrating a network of components for the delivery of content in an educational context according to embodiments of the present invention.

FIG. 2 illustrates a computing system used in the network for delivery of content in an education context according to embodiments of the present invention.

FIG. 3 illustrates the distribution of educational content by the central and local servers and the gateway infrastructure according to embodiments of the present invention.

FIG. 4 illustrates the distribution of educational content by a gateway in a school network according to embodiments of the present invention.

FIG. 5 illustrates the contents of the targeter data attributes 401 according to embodiments of the present invention.

FIG. 6 is a flowchart illustrating the behavior of a receiving device process according to embodiments of the present invention.

FIG. 7 is a flowchart illustrating the targeting process according to embodiments of the present invention.

FIG. 8 is a block diagram illustrating the logical arrangement of creating a combined targeter according to embodiments of the present invention.

FIG. 9 is a functional block diagram illustrating the indirect delivery of content in an education context according to embodiments of the present invention.

FIG. 10 is a flowchart illustrating in more detail the method for sending information over a communications medium according to embodiments of the present invention.

FIG. 11 is a flowchart illustrating the management of messages by a management processing application, according to embodiments of the present invention.

FIGS. 12A-12D are flowcharts illustrating the management of a message by the message processing application, according to embodiments of the present invention.

FIG. 13 is a functional block diagram illustrating an alternative network of components for the delivery of content in an education context according to embodiments of the present invention.

### DETAILED DESCRIPTION OF THE INVENTION

The present invention provides an improved method and system for over-the-network delivery of content in an educational context. The following description is presented to enable one of ordinary skill in the art to make and use the present invention and is provided in the context of a patent application and its requirements. Various modifications to the embodiment will be readily apparent to those skilled in the art and the generic principles herein may be applied to other embodiments. Thus, the present invention is not intended to be limited to the embodiment shown but is to be accorded the widest scope consistent with the principles and features described herein.

The present invention can take the form of an entirely hardware embodiment, an entirely software embodiment or an embodiment containing both hardware and software elements. In a preferred embodiment, the present invention is implemented in software, which includes but is not limited to firmware, resident software, microcode, etc.

Furthermore, the present invention can take the form of a computer program product accessible from a computer usable or compute readable storage medium providing program code for use by or in connection with a computer or any instruction execution system. For the purposes of this description, a computer usable or computer readable storage medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, point devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

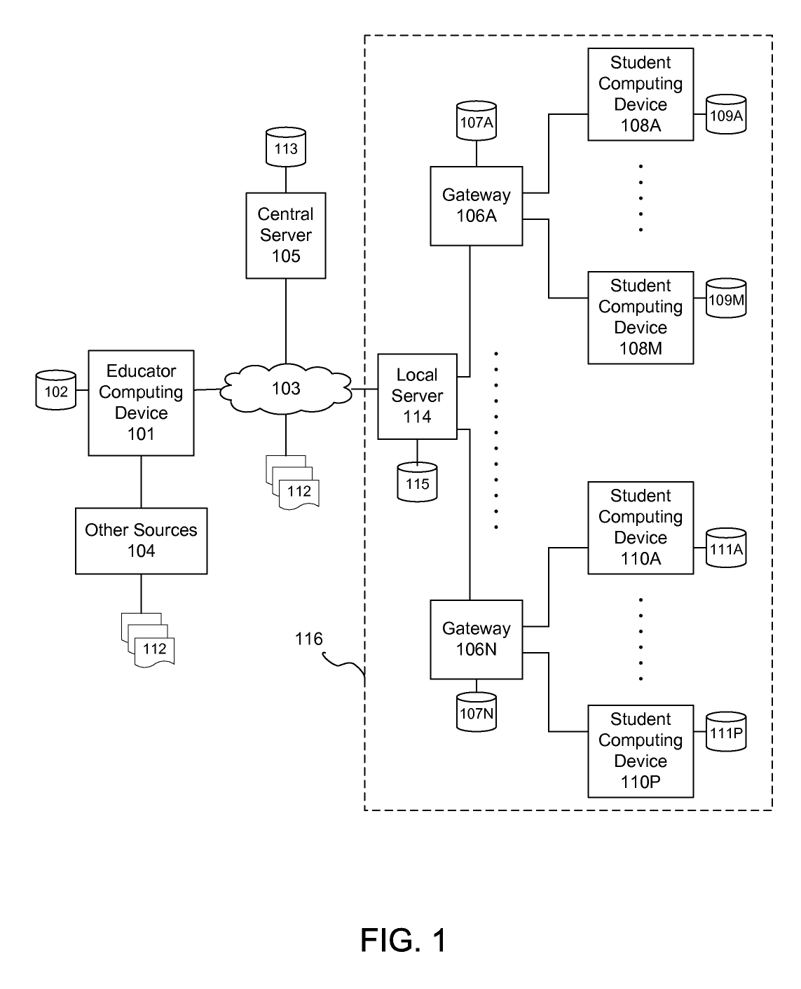

FIG. 1 is a functional block diagram illustrating a network of components for the delivery of content in an educational context according to embodiments of the present invention. The components of the network includes an educator computing device 101 coupled to a datastore 102 accessible to the educator computing device 101. Via the educator computing device 101, an educator may obtain learning materials 112 over the Internet 103 and from non-Internet sources 104. The educator computing device 101 connects with a central server 105 coupled to a datastore 113 accessible to the server 105. The server 105 connects with one or more local servers 114 at one or more school locations 116, each coupled to a datastore 115 accessible to the local servers 114. FIG. 1 illustrates one example school location 116. Other school locations may have the same or similar infrastructures. Each local server 114 connects with a gateway infrastructure comprising a plurality of gateways 106A-106N, each coupled to a datastore 107A-107N. Each gateway 106A-106N may be connected to one or more student computing devices 108A-18M, 110A-110P. For example, gateway 106A may be connected to student computing devices 108A-108M, while gateway 106N may be connected with student computing devices 110A-110P. Each student computing device 108A-108M, 110A-110P is coupled to a datastore 109A-109M, 111A-111P. The educator computing device 101 and the student computing devices 108A-108M, 110A-110P may be a personal computer, a laptop, a tablet, a smartphone, or other such computing device. In one embodiment, one or more of the datastores (102, 113, 107A-107N, 109A-109M, and 111A-111P) are local to its respective component. Any component in the network may be implemented on the same hardware or in separate hardware. Components may be implemented together, or as a number of components. For example, the local server and gateway functions may be implemented on the same computing system. Further, student computing devices 108A-108M, 110A-110P may connect to a gateway via an access point, or the gateway may function as an access point.

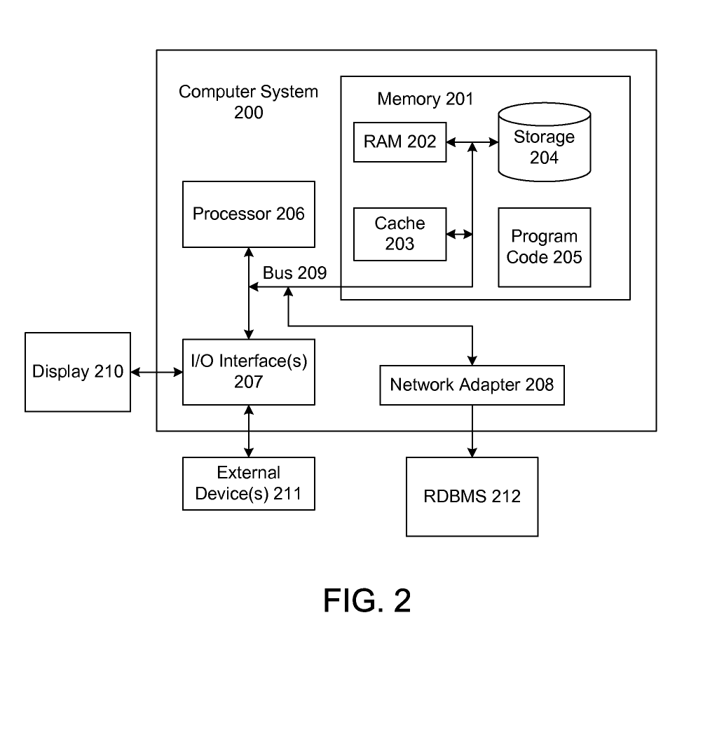

In this embodiment, the educator computing device 101 and the central server 105 connect over the Internet 103. The central server 105 in turn connects with each local server 114 over the Internet 103. Alternatively, the devices connect over a school's private Wide Area Network (WAN). Each local server 114 and the gateways 106A-106N, as well as the gateways 106A-106N and the student computing devices 108A-108M, 110A-110P, connect within the school's network without traversing the Internet. The connection may be of any type or combination thereof of a broadcast communications medium, a wired communications medium, or wireless a communications medium. For example, the transmission of data between two or more of the devices illustrated in FIG. 1 may be broadcast over a digital television (DTV) signal, i.e., datacast, allowing for expanded coverage at a low cost of transmission. The gateways 106A-106N provide network coverage within a school's premises, but may also be extended beyond. For example, gateways may be deployed on school buses or in determined student gathering locations. The DTV may be managed by the school or by an external entity. Alternatively, a cellular network hosted by a wireless telecommunications provider or a Wi-Max (802.16) service provider may be used. Each of the components illustrated in FIG. 1 may be a computing system of the type illustrated in FIG. 2.

FIG. 2 illustrates a computing system used in the network for delivery of content in an education context according to embodiments of the present invention. The computing system 200 is operationally coupled to a processor or processing units 206, a memory 201, and a bus 209 that couples various system components, including the memory 201 to the processor 206. The bus 209 represents one or more of any of several types of bus structure, including a memory bus or memory controller, a peripheral bus, an accelerated graphics port, and a processor or local bus using any of a variety of bus architectures. The memory 201 may include computer readable media in the form of volatile memory, such as random access memory (RAM) 202 or cache memory 203, or non-volatile storage media 204. The memory 201 may include at least one program product having a set of at least one program code module 205 that are configured to carry out the functions of embodiments of the present invention when executed by the processor 206. The computing system 200 may also communicate with one or more external devices 211, such as a display 210, via I/O interfaces 207. The computing system 200 may communicate with one or more networks via network adapter 208.

An educator uses an application executing on the educator computing device 101 to create lessons and assignments. The educator computing device 101 obtains learning resources 112 over the Internet 103 and from other sources 104, as directed by the educator. A “learning resource”, as used in this specification, refers to content to be shared with students as part of a lesson. The content may be in a file of any type, including but not limited to documents, video, images, and off-lined websites. The educator computing device 101 stores the learning resources 112 at the datastore 102. For example, instead of storing a link to a video, the video itself is downloaded, with or without conversion to a recognizable format (e.g. WMV, FLV, MP4, AVI, etc.). The educator computing device 101 then creates a lesson using the lesson resources 112 in the datastore 102, as directed by the educator. A “lesson”, as used in this specification, refers to a collection of learning resources. The educator computing device 101 then creates an assignment by scheduling the lesson to be sent to students and defining certain associated metadata. The schedule sets forth the times during which the assignment is considered “active” and available for distribution throughout the system and/or to student computing devices. For example, the metadata may define a delivery schedule of assignments by a gateway to a student computing device and/or a broadcast schedule of assignments from the local server 114 to a gateway. The educator can choose to immediately send the lesson or add the lesson to a queue for future distribution. Metadata defined by the educator may include one or more of: title, description, category, teacher ID assigned to the educator, class ID assigned to the class to which the lesson applies, and a grade ID for the grade of the class. For example, a lesson may include a video for a 5^{th} grade science class taught by Ms. Smith. The metadata associated with the lesson thus may include: a title of the video, a description of the video, a unique ID for Ms. Smith, a unique class ID for the science class, and a grade ID of 5. The educator may also choose to send the lesson to select students within a class. For example, a social studies teacher can send some students a lesson with certain videos while simultaneously working with the other students in the class on other materials. The unique ID's assigned to the select students may be configured as part of the metadata associated with the assignment to indicate that the assignment is to be sent to these select students. The metadata set forth here are for illustrative purposes and other metadata are possible without departing from the spirit and scope of the present invention. The educator computing device 101 then uploads the assignment to the central server 105.

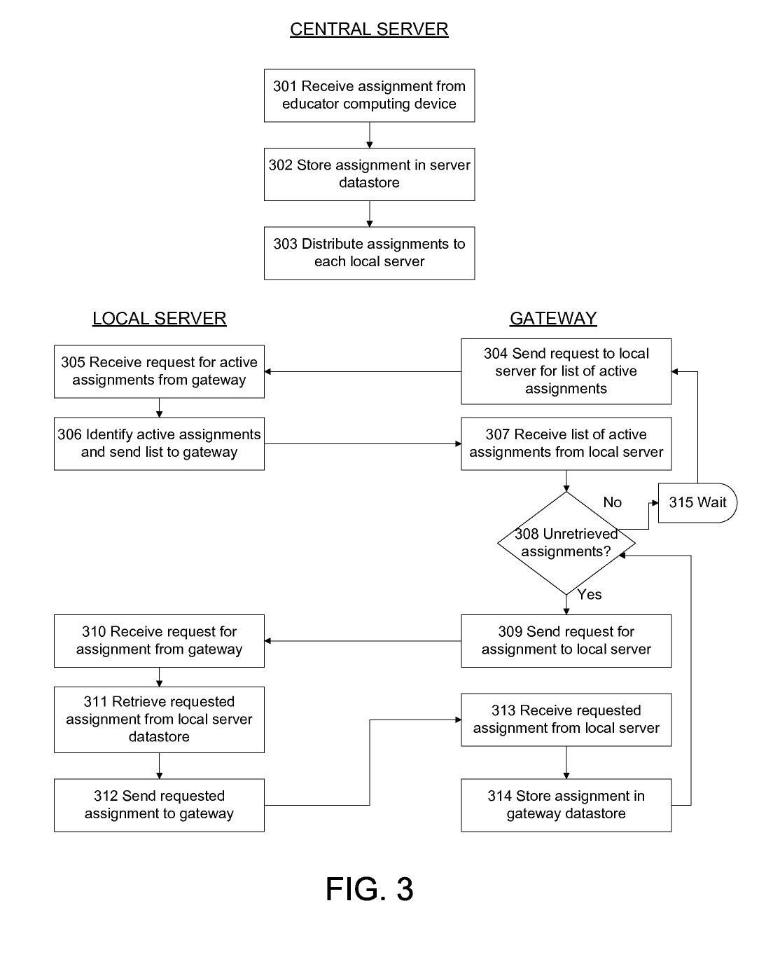

FIG. 3 illustrates the distribution of educational content by the central and local servers and the gateway infrastructure according to embodiments of the present invention. First, the server 105 obtains the educational content from the educator computing device 101. In obtaining the educational content, the central server 105 connects with the educator computing device 101 and receives the assignment (301). The assignment includes the lesson resources in the lesson, the schedule for distributing the lesson, and the metadata associated with the assignment. The central server 105 stores the assignment in the server's datastore 113 (302) and distributes the assignments to each of the local server 114 (303), either by the central server 105 contacting the local server 114 or vice versa. The process of uploading assignments to the central server 105 occurs concurrently with the distribution of assignments already stored at the central server's datastore 113. The process of uploading assignments to the local server 114 may also occur concurrently with the distribution of assignments already stored at the local server's datastore 115. In distributing the assignments by a local server 114, a given gateway 106A sends a request to the local server 114 for a list of active assignments stored at the local server's datastore 115 (304). In response to receiving the request (305), the local server 114 identifies the active assignments stored in the datastore 115 and sends the list of the active assignments to the requesting gateway (306). In this embodiment, what assignments are active is determined by the schedule associated with the assignment.

When the gateway 106A receives from the local server 114 the list of active assignments stored in the local server's datastore 115 (307), the gateway 106A determines whether there are any assignments on the list unretrieved by the gateway 106A (308). If there is an unretreived assignment, then the gateway 106A sends a request for the assignment to the local server 114 (309). In this embodiment, the list includes the metadata of each active assignment in the local server's datastore 115. The gateway 106A processes the metadata and determines whether or not to request the assignment. For example, the gateway 106A may request any assignment that's on the list but does not exist in the gateway's datastore 107A. For another example, the gateway 106A may be configured to request only unretrieved assignments with a particular teacher ID, a particular class ID, and/or a particular grade ID. When the teacher ID, class ID, and/or grade ID in the assignment metadata matches the teacher ID, class ID, and/or grade ID configured for the gateway 106A, the gateway 106A requests the assignment.

In response to receiving the request for the assignment from the gateway 106A (310), the local server 114 retrieves the requested assignment from the local server's datastore 115 (311) and sends the requested assignment to the gateway 106A (312). The gateway 106A receives the requested assignment from the local server 114 (313) and stores the assignment in its datastore 107A (314). Steps 308-314 are repeated until there are no more unretrieved assignments on the list. The gateway 106A then waits for a predetermined period of time (315) before sending another request to the server 105 for a list of active assignments. The wait time may be configured based on the frequency in which the list of active assignments may change.

Although the present invention is described with the central server 105 distributing assignments to the local server 114, the local server and gateway functions may be implemented on the same computing system as a combined component. The educator computing device 101 then would upload assignments to this combined component. The local server or the gateway function in the combined component may then distribute assignments to other gateways in the network or to the student computing devices 108A-108M, 110A-110P. Alternatively, multiples of combined components may be deployed, any of which may receive assignments from the central server 105 and distribute assignments to the student computing devices 108A-108M, 110A-110P. Which combined component receives the assignment may be based on configuration. For example, a given combined component may be configured to receive assignments with particular teacher ID's, class ID's, grade ID's, etc., or some combination thereof.

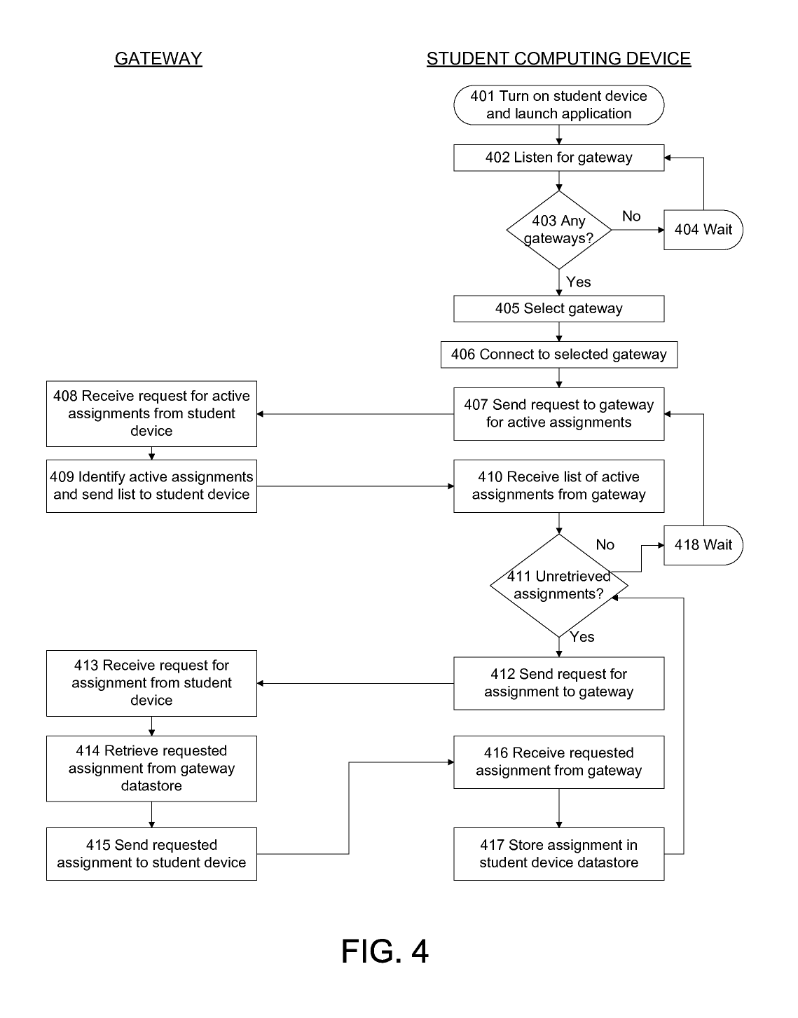

FIG. 4 illustrates the distribution of educational content by a gateway in a school network according to embodiments of the present invention. In this embodiment, each student computing device may be configured with any combination of the student's unique ID, the class IDs of the classes in which the student is enrolled, the teacher ID's of the teachers of the enrolled classes, the grade ID for the grade the student is in, and any other metadata deemed relevant. First, the student computing device 108A is turned on and launches an application executing on the student device 108A for obtaining assignments (401). The student computing device 108A listens for one or more gateways in the school gateway infrastructure (402). Until the student computing device 108A comes within range of the school gateway infrastructure, no gateways would be found (403). In this embodiment, the student computing device 108A is listening for a network-message based “beacon” that announces the presence of the gateway. In this embodiment, this beacon message would only be announced in environments where there is sufficient bandwidth for a student computing device to download content distributed by the server 105. This feature is an implied location or infrastructure attribute based on the observation for a local network service identifier. Where this network identifier is observed, the student computing device 108A can attempt to connect with the gateway.

The student computing device 108A waits (404) until it comes within range of such a gateway. Once within range, the student computing device 108A selects one of the gateways found, such as gateway 106A (405). A load balancing mechanism may be used to select the gateway, such as but not limited to random selection of a top percentile of gateways, round-robin selection, selection by priority, or selection by gateway configuration. For example, when selecting by gateway configuration, the student computing device 108A may be configured for a 6^{th} grade student, and the gateway 106A is configured to distribute assignments for 6^{th} grade classes. The student computing device 108A would then select gateway 106A. The student computing device 108A then connects to the selected gateway 106A (406). In one embodiment, the student computing device 108A may ask a known or previously identified device (such as a gateway 106A or a local server 114) for a list of usable gateways for content download. In another embodiment, the student computing device 108A may be preconfigured for a list of gateways or may always use a preconfigured gateway.

Once connected to the gateway 106A, the student device 108A sends a request to the gateway 106A for a list of active assignments stored in the gateway's datastore 107A (407). The gateway 106A receives the request (409), and in response, identifies the active assignments stored in the datastore 107A and sends the list of the active assignments to the requesting student computing device 108A (409). In this embodiment, what assignments are active is determined by the schedule associated with the assignment. When the student device 108A receives the list of active assignments from the gateway 106A (410), the student computing device 108A determines whether there are any assignments on the list unretrieved by the student computing device 108A (411). In this embodiment, the list includes the metadata of each active assignment in the gateway's datastore 107A. The student computing device 108A processes the metadata and determines whether or not to request the assignment. For example, the student computing device 108A may be configured with the user's student ID, the grade ID for the grade the student is in, the class ID's of the classes in which the student is enrolled, and the teacher ID's of the teacher of the classes. The assignment may be configured to be distributed only to student computing devices configured with a particular combination of teacher ID, class ID, grade ID, and student ID parameters. When the combination of the teacher ID, class ID, grade ID, and/or student ID in the assignment metadata matches the parameters configured for the student computing device 108A, the student computing device 108A sends a request for the assignment to the gateway 106A (412). Upon receiving the request for the assignment (413), the gateway 106A retrieves the requested assignment from the gateway's datastore 107A (414) and sends the requested assignment to the student computing device 108A (415). The student computing device 108A receives the requested assignment from the gateway 106A (416) and stores the assignment in its datastore 109A (417). Steps 411-417 are repeated until there are no more unretrieved assignments on the list. The student computing device 108A then waits for a predetermined period of time (418) before sending another request to the same gateway 106A or another gateway in the gateway infrastructure for a list of active assignments. The wait time may be configured based on the frequency in which the list of active assignments may change and may be part of the beacon message. The assignments may be broadcast from the central server 105 to the local server 114, from the local server 114 to a gateway, or from gateway to gateway. The broadcast may be performed in response to a request for assignments or without first requiring a request. The receiving server or gateway may then determine how to process the content using the targeting process, described further below. Alternatively, the sending server or gateway performs the targeting process to determines whether or not to send the content the receiving server or gateway to avoid any “download and discard” situations.

In the network described above, only the educator computing device 101 may need access to the Internet to obtain the educational content 112. The distribution of the assignment to the gateways 106A-106N and student computing devices 108A-108M, 110A-110P does not require access to the Internet. One copy of the education content 112 is uploaded to the central server 105, and one copy of the educational content 112 in the assignment is uploaded to each local server 114 and stored or cached in the local server's datastore 115. Copies of the educational content 112 in the assignments are then distributed to the gateways 106A-106N and stored or cached in the gateways' datastore 107A-107N. The gateways 106A-106N then distributes copies of the education content 112 in the assignments to the appropriate student computing devices 108A-108M, 110A-110P, which are stored or cached in the student computing devices' datastores 109A-109M, 111A-111P. In this manner, a multiple leveled cached distribution system is provided, which significantly decreases the network bandwidth to the Internet required for delivering educational content to the students. This caching scheme reduces dependence of external WAN connectivity, reduces bandwidth consumption, redistributes network loads, and increase student download speeds. For example, assume a teacher assigns a given video as part of a class's homework assignment. The teacher downloads the video from the Internet to the educator computing device 101 and uploads the video as part of the homework assignment to the central server 105. A copy of this video is distributed as part of the homework assignment to the gateways 106A-106N and eventually to the student computing devices of her students. Assume for example that the teacher has 100 students in her classes to which the homework assignment is assigned. With the present invention, the 100 students would download a copy of the video from the school's internal network, which could localize device traffic with regard to this infrastructure. This avoids the need for 100 student computing devices to access the Internet, with each accessing the same content. This increases the efficiency of the school's bandwidth usage. Further, because the student computing devices are able to obtain a locally stored copy of the video through the school's internal network, the student need not have Internet access outside of school. The need for individual student Internet connection for content access is reduced or even eliminated. Only proximity to a gateway is necessary to download assignments to student computing devices. Once downloaded, the files may be accessed and used on the student computing device anywhere. Further, the educational content received by the students are ensured to have been previously vetted by an educator, and possibly also by the school district's central office, and deemed appropriate for the student to which the assignment is intended. The educator and/or the central office may be given the option to remove or edit inappropriate portions of the content prior to distribution to the students.

In addition to distributing assignments, the system according to the present invention may also send management messages. For example, messages may be sent to remove expired assignments from student computing devices. Other messages may be sent to update teacher ID's, class ID's, or other system-set values.

In addition to distributing messages to student computing devices, the system according to the present invention may also send messages from school administrators or teachers to parents. Parent computing devices may be registered with the system, and district-wide content (such as notes, announcements, videos of PTA meetings, video message from teachers, etc.) may be sent to via the central server 105, the local servers 114, and gateway infrastructure to the parent computing devices. Parent computing devices may connect to a gateway in the school's system and request a list of active messages in a similar manner as the student computing devices, as described above. School specific messages may also be sent via the local server 114 without involving the central server 105. Further, the system may also be used to send messages from school administrators to teacher computing devices via the central server 105. The administrator computing device would upload messages to the central server 105, similarly to the educator computing device, and the teacher computing devices would connect to the central server 105 and request a list of active messages, similarly to the student computing device, as described above. For example, administrator may use the system to standardize video or other content for multiple schools, or to control certain dictated curriculum items.

Within one embodiment, a targeting method and system as described in U.S. Pat. No. 8,503,925 ('925 patent), which is incorporated by reference herein in its entirety, may be used in determining whether to accept a distributed message or whether there are any unretrieved assignments on the list. Here, the “list” of assignments may be in the form of messages containing targeter data attributes.

According to a feature of the invention, targeting is accomplished with a data structure called a targeter that is an expression attached to a transmitted data package or stored in a receiving device and that contains logical formulas called selectors, each paired with a short code, or action identifier, and a set of key values pairs that are descriptors.

After a device, such as the local server 114, gateway 106A-106N, or student computing devices 108A-108M, 110A-110P, receives a message targeting occurs as follows. The receiving device evaluates each selector in the message and each selector stored in the receiving device. If any selector evaluates to true, the action described by the action identifier paired with that selector is carried out.

The selectors are typically compound Boolean expressions. There may be sub expressions that may be other Boolean expressions or function invocations. Functions that may be used in selectors include relational operators, such as equals or less than. Sub expressions may name keys from the descriptors in the message or the descriptors stored in the device.

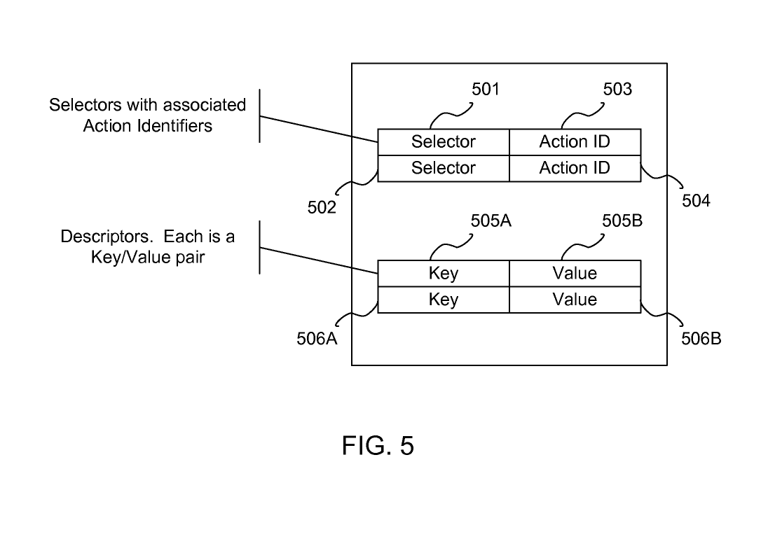

FIG. 5 illustrates the contents of the targeter data attributes 401 according to embodiments of the present invention. There are selectors, such as 501 and 502 associated with action identifiers, such as 503 and 504, respectively. An action identifier describes a delivery action to be taken when a selector evaluates to True. Each descriptor comprises a key value pair such as 505A-505B and 506A-506B. When transmitted, target data attributes are represented as a potentially short XML (Extensible Markup language) document following a widely used DTD or XDS (Document Type Definition, XML Schema Definition: declarations that define a document type for the XML language). If XML is not feasible in a given deployment for some reason, JavaScript Object Notation (JSON) or any serializable representation may be used. In a device, they may be stored in any convenient representation. A selector is a Boolean expression over the keys and the descriptors in the message and the descriptor stored in the receiving device. The syntactic representation of selectors may be one of many representations with identical semantics that will be apparent to one of ordinary skill in the art. Descriptors are shown in FIG. 5 as key-value pairs. In some embodiments, the keys are stored explicitly in the descriptors. In another embodiment, the keys are not stored explicitly but are implicitly represented based on the position of the descriptors in the data structure. In still another embodiment, some keys are implicitly represented and some are stored explicitly.

Some key-values pairs used in a targeter's selector expression may not be part of the message, instead they may be defined by the receiver itself. For instance a selector may contain an expression that uses the Latitude and Longitude of the receiver, which would be a descriptor provided by the receiver during selector evaluation.

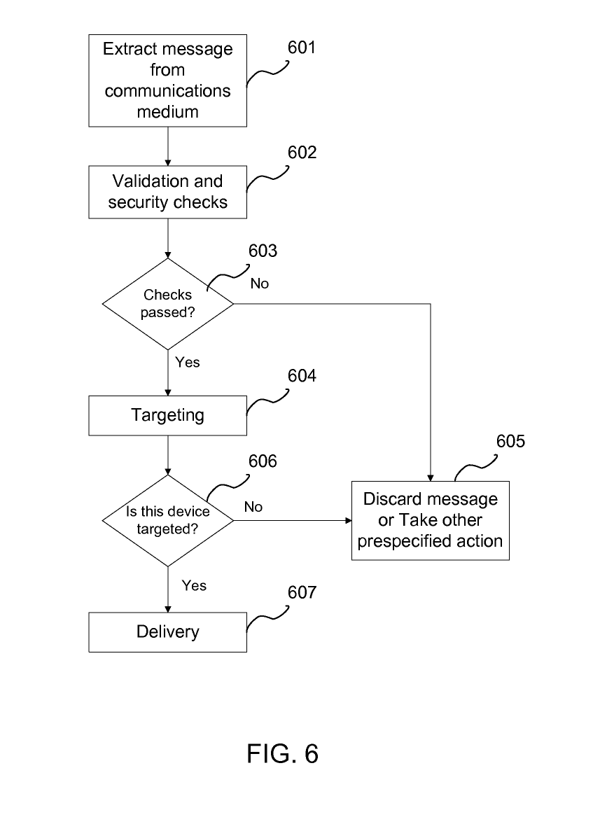

FIG. 6 is a flowchart illustrating the behavior of a receiving device process according to embodiments of the present invention. The device first extracts the message from the communications medium (601) and performs validation and security checks (602). If the checks are passed (603), the device proceeds with the targeting (604). If not, the device discards the message or takes other pre-specified action (605). In the targeting, the device evaluates each selector in the message and each selector stored in the device by creating a combined targeter, as described below. If any selector evaluates to true (606), then the device is targeted, and it proceeds to the delivery (607) in which the actions associated with the selector are carried out. If the device is not targeted, it proceeds to discard the message or take other pre-specified action (605).

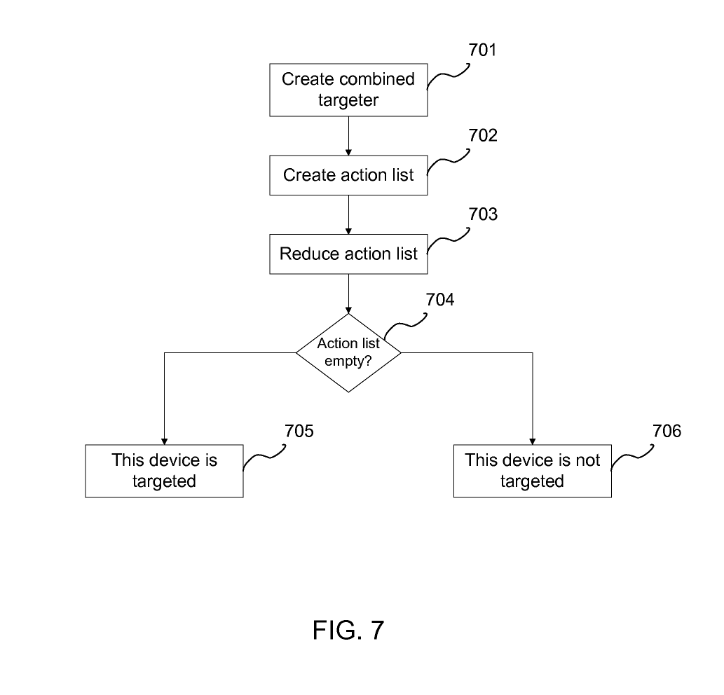

FIG. 7 is a flowchart illustrating the targeting process according to embodiments of the present invention. The first step 701 involves creating a combined targeter. The next step 702 involves creating an action list. The next step 703 involves reducing the action list. The next step 704 is a decision step; if the action list is empty, proceed to step 705 indicating this device is not targeted. If the action list is not empty, proceed to the next step 706 indicating that this device is targeted.

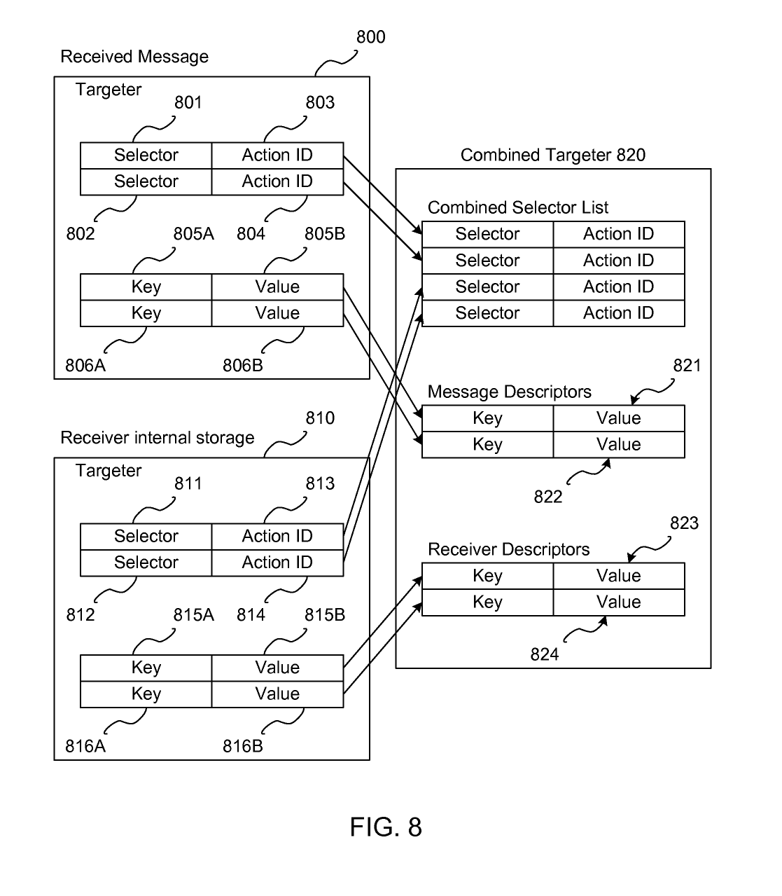

FIG. 8 is a block diagram illustrating the logical arrangement of creating a combined targeter according to embodiments of the present invention. A received message contains targeter 800 shown having a pair of selectors 801 and 802 associated with action ID's 803 and 804, respectively and keys 805A and 806A associated with values 805B and 806B, respectively.

Receiver internal storage has targeter 810 that is structured as illustrated in FIG. 5, with selectors 811 and 812 associated with action ID's 813 and 814, respectively, and keys 815A and 816A associated with values 815B and 816B, respectively.

Combined targeter 820 is shown with four selectors receiving action ID from the action ID's in targeters 800 and 810 associated with respective action ID's. Combined targeter 820 also has message descriptors 821 and 822 that receive the key value from targeter 800 and receiver descriptors 823 and 824 that receive key values from the receiver internal storage.

Within a school's premises, educational content may also be received indirectly from the local server 114, where the content is relayed by another “direct” or “primary” gateway, in the manner described in U.S. patent application Ser. No. 13/892,344, titled “Improved Techniques for Sending and Relaying Information Over Broadcast and Non-Broadcast Communications Media”, filed on May 13, 2013. This patent application is hereby incorporated by reference herein in its entirety.

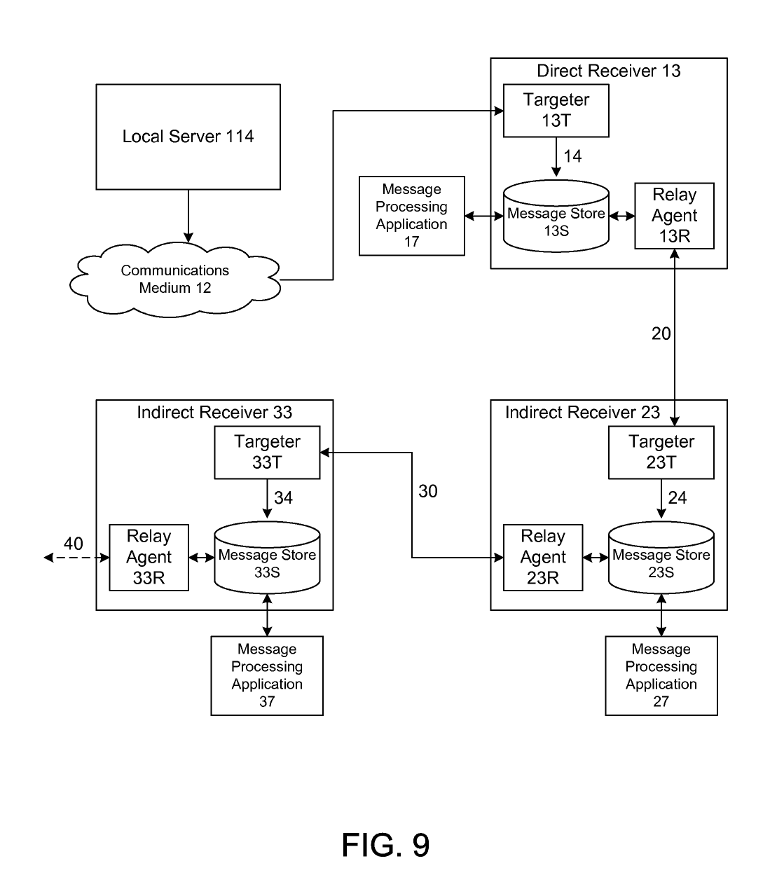

FIG. 9 is a functional block diagram illustrating the indirect delivery of content in an education context according to embodiments of the present invention. The local server 114 transmits information over a communications medium 12 to a direct receiver 13. In the present context, a direct receiver is a gateway 106A-106N. For example, the local server 114 may be coupled to an ATSC transmitter broadcasting data using one or more digital TV signals; the communications medium 12 may be television waves; and the direct receiver 13 may be a laptop computer equipped with a digital TV receiver component and software. For a given communications medium and local server, there is a coverage area where the direct receiver 13 can receive the data broadcast by the local server 114.

In further examples, the local server 114 may be coupled to a satellite or airborne transmitter, the communications medium 12 may be microwaves, and the direct receiver 13 may be a mobile or desktop computer equipped with a receiver component to receive signals from the local server 114. The SIRIUS® satellite broadcasting system may be used. However, any convenient form of server, communications medium, and receiver component may be used, and different kinds may be used in combination. A communications medium may for example be electromagnetic, acoustic, visible light, ground waves, or a network supporting broadcast transmissions, or a combination. The communications medium may also make use of relays, and there may be more than one sender and there may be more than one receiver component.

The direct receiver 13 includes a targeter component 13T and a message store 13S. The message store 13S stores messages selected or chosen by the targeter component 13T. In some embodiments, a number of targeter data attributes or metadata are associated with each message. The targeter component 13T selects messages to be stored in the message store 13S based on targeter data attributes.

The message store 13S stores the messages received and selected by the targeter component 13T. When the direct receiver 13 is not in the coverage area, the message store 13S retains messages that the receiver has received. The message store 13S makes its messages accessible to a message processing application 17 and to a relay agent 13R as described below. There may be any number of message processing applications and/or relay agents, and there may be a number of message stores in a distributed, fail-over, or other configuration.

The message store 13S may be implemented using a relational database, data structures in memory accessible to a processor, or other form of storage. In some embodiments, the message processing application 17 and/or relay agent 13R receives a notification when a message has been placed in the message store 13S for the message processing application 17 to process. In some embodiments the message processing application 17 and/or the relay agent 13R may poll or access the message store 13S to determine whether there are messages for the message processing application 17 to process. Other techniques for messages of the message store 13S to be accessible to the relay agent 13R or the message processing application 17 may be employed as well.

A message-processing application 17 is an application that processes one or more messages of the message store 13S. A message processing application 17 accesses or is provided a message in the message store 13S and performs a number of operations based at least in part on information of the message.

In some embodiments the message processing application 17 may obtain a message from the message store 13S by providing a message request to the message store 13S. In response to the message request, the message store 13S may provide a message to the message processing application 17. In some embodiments, the message-processing application 17 interacts with the message store 13S in further ways. For example, the message-processing application 17 may cause the message to be deleted from the message store 13S, may update one or more messages or other data of the message store 13S, or add a further message to the message store 13S.

In some embodiments, a message-processing application 17 may cause a change to one or more components of the system, such as: updating or changing the receiving settings or other data or characteristics of the receiver 13R; displaying information for a user, or receiving input from a user, or interacting with one or more users in another fashion such as by a user interface; transmitting data or exercising control over an attached or embedded device; or transmitting, receiving, or providing data from other components.

A relay agent 13R also can access or be provided a number of messages from the message store 13S. The relay agent 13R provides messages from the message store 13S to an indirect receiver 23. In the present context, an indirect receiver is a receiver that receives messages of a sender via a relay agent of another receiver. The indirect receiver, for example, may be another gateway or a student computing device functioning as a hotspot. The indirect receiver 23 has a targeter component 23T, a message store 23S, and a message processing application 27. An indirect receiver 23 may perform functionalities similar to a direct receiver 13 by receiving messages of the local server 114 via a relay agent from the message store 13S of another receiver such as direct receiver 13. An indirect receiver may also have a relay agent 23R for providing messages from the message store 23S to another indirect receiver, such as indirect receiver 33, over another communications medium 30. The indirect receiver 33 also includes a targeter 33T, a message store 33S, a relay agent 33R, and a message processing application 37. The indirect receiver 33 may perform the functionalities similar to the indirect receiver 23 by receiving messages via a relay agent 23R from the message store 23S of another indirect receiver such as indirect receiver 23.

In some embodiments, the relay agent 13R is provided message requests from an indirect receiver 23, and in response, provides messages in message store 13S to the indirect receiver 23 via a communications medium 20. For example, the non-broadcast communications medium 20 may be a link over a wired or wireless network, a serial communications link, one or more data pipes, or a logical link, or a combination. In many embodiments, the communications medium 20 is logically distinct from the broadcast communications medium 12.

Components may be implemented together, or as a number of components. For example, a receiver may be both a direct receiver and an indirect receiver. A first direct receiver may function as an indirect receiver to a second direct receiver when the first receiver is not in the coverage area of the sender. The first and second receiver may receive and provide messages in a store-and-forward fashion. As a further example, a first and a second receiver may be connected logically via their respective relay agents as a direct and an indirect receiver to each other, and may manage their respective message stores so that messages are not repeatedly stored in a looping fashion, and to achieve failure survivability for an event such as different direct receivers are affected differently by failures in the broadcast medium, a sender, or a receiver being out of the coverage area of the sender.

The relay agent 13R may also accept other data or information from the indirect receiver 23, for example to delete, update, or add messages from the message store 13S in response to an action of a message processing application 27 of the indirect receiver 23. In some embodiments, the indirect receiver 23 provides the other information to maintain integrity between copies of a same message of both message store 23S and message store 13S, such as to delete a message from the message store 13S when it is deleted from message store 23S.

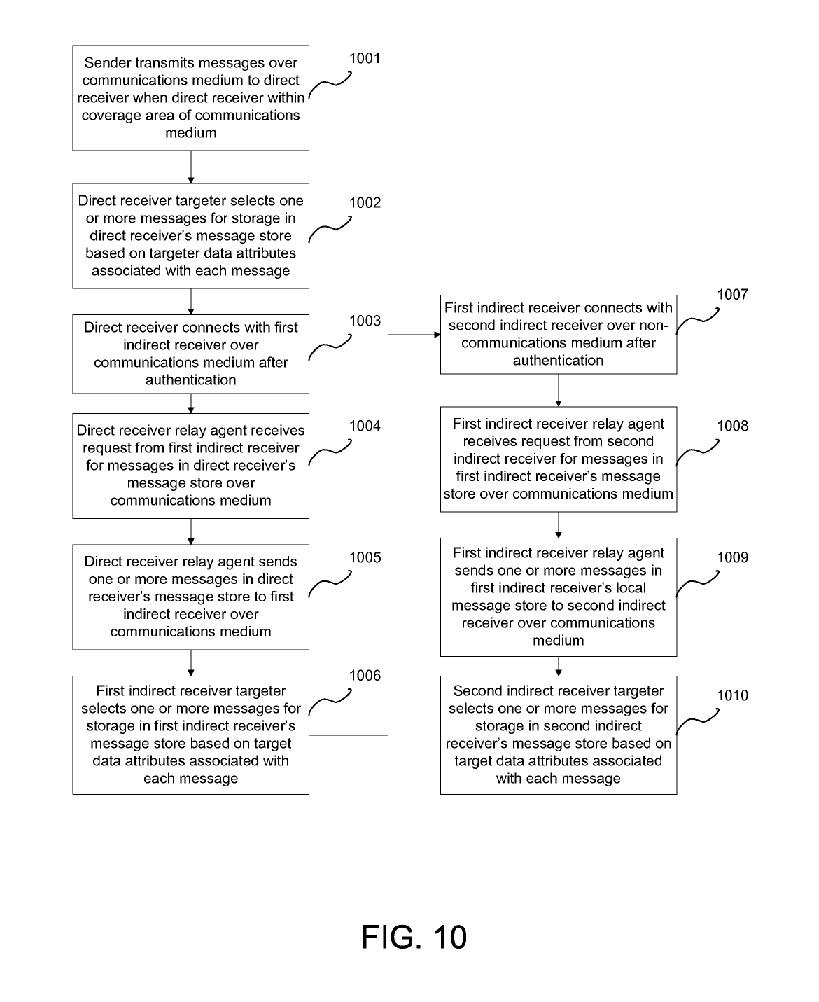

FIG. 10 is a flowchart illustrating in more detail the method for sending information over a communications medium according to embodiments of the present invention. Referring to both FIG. 9 and FIG. 10, the local server 114 transmits messages over the communication medium 12 to the direct receiver 13 when the direct receiver 13 is within the coverage area of the communications medium 12 (1001). The direct receiver's targeter 13T selects one or more messages to be stored on the direct receiver's message store 13S based on the targeter data attributes associated with each message from the sender (1002). At some point in time, the direct receiver 13 connects with the first indirect receiver 23 over a communications medium 20, after the first indirect receiver 23 is authenticated (1003). The direct receiver's relay agent 13R then receives over the communications medium 20 a request from the first indirect receiver 23 for messages in the direct receiver's message store 13S (1004). In response, the direct receiver's relay agent 13R sends one or more messages in the direct receiver's message store 13S to the first indirect receiver 23 over the communications medium 20 (1005). In one embodiment, the relay agent 13R sends all messages in its message store 13S to the indirect receiver 23. In another embodiment, the relay agent 13R sends less than all of the messages in its message store 13S to the indirect receiver 23. For example, the relay agent 13R may send only those messages that the indirect receiver 23 is determined to be allowed access or determined to be able to understand, based on the target data attributes associated with the messages.

The relay of messages to the indirect receiver 23 may occur at any point in time after the relay agent 13R receives the message request. Further, the relay of message to the indirect receiver 23 may occur over more than one connection. For example, the indirect receiver 23 may move out of the direct receiver's 13 coverage area after the relay begins. When the indirect receiver 23 moves again inside the direct receiver's 13 coverage area, the relay may resume. For another example, the messages may be repeatedly relayed at differing temporal rates, depending on the criticality of the information in the message. Other variations in relaying of the messages may be possible without departing from the spirit and scope of the present invention.

Upon receipt of the messages from the relay agent 13R, the first indirect receiver's targeter 23T selects one or more of these received messages for storage in the first indirect receiver's messages store 23S based on the target data attributes associated with each message (1006).

Optionally and at some point in time, the first indirect receiver 23 connects with a second indirect receiver 33 over a communications medium 30, after the second indirect receiver 33 is authenticated (1007). The communications media 20 and 30 can be the same type or different types of communications media. The first indirect receiver's relay agent 23R then receives a request from the second indirect receiver 33 for messages in the first indirect receiver's message store 23S over the communication medium 30 (1008). In response, the first indirect receiver's relay agent 23R sends one or more messages in the first indirect receiver's message store 23S to the second indirect receiver 33 over the communications medium 30 (1009). In one embodiment, the relay agent 23R sends all messages in its message store 23S to the second indirect receiver 33. In another embodiment, the relay agent 23R sends less than all of the messages in its message store 23S to the second indirect receiver 23. For example, the relay agent 23R may send only those messages that the second indirect receiver 23 is determined to be allowed access or determined to be able to understand.

Upon receipt of the messages from the relay agent 23R, the second indirect receiver's targeter 33T selects one or more of these received messages for storage in the second indirect receiver's messages store 33S based on the target data attributes associated with each message (1010).

In this manner, one or more indirect receivers are able to receive messages indirectly from the sender via another receiver when the receiver will not or cannot receive messages directly from the sender.

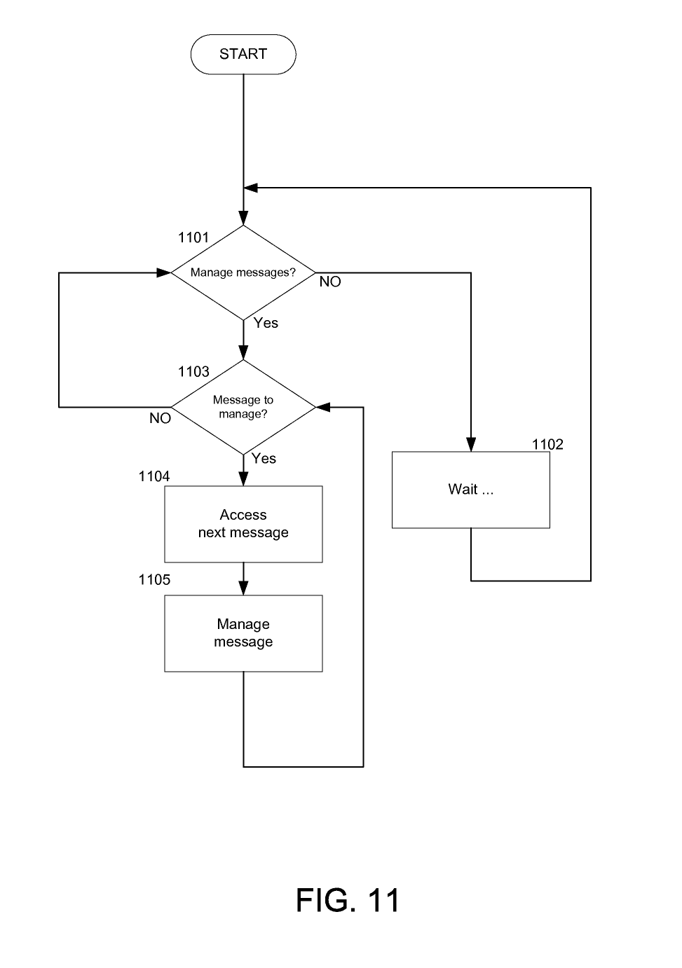

In one embodiment of the present invention, a message processing application running on a server or gateway manages the processing of received messages. FIG. 11 is a flowchart illustrating the management of messages by the message processing application, according to embodiments of the present invention. The message processing application determines whether it is appropriate to manage messages at the current time (1101). The determination may be made by a fixed or variable time polling loop, by checking whether any messages stored in the message store 13S. If it is not appropriate to manage messages at the current time, the message processing application waits for a period of time (1102), before returning to determine again whether it is appropriate to manage messages (1101). In one alternative embodiment, the message processing application waits until some condition occurs before making the determination again, for example, an event indication that a new message has been added or a message has been modified by a message processing application.

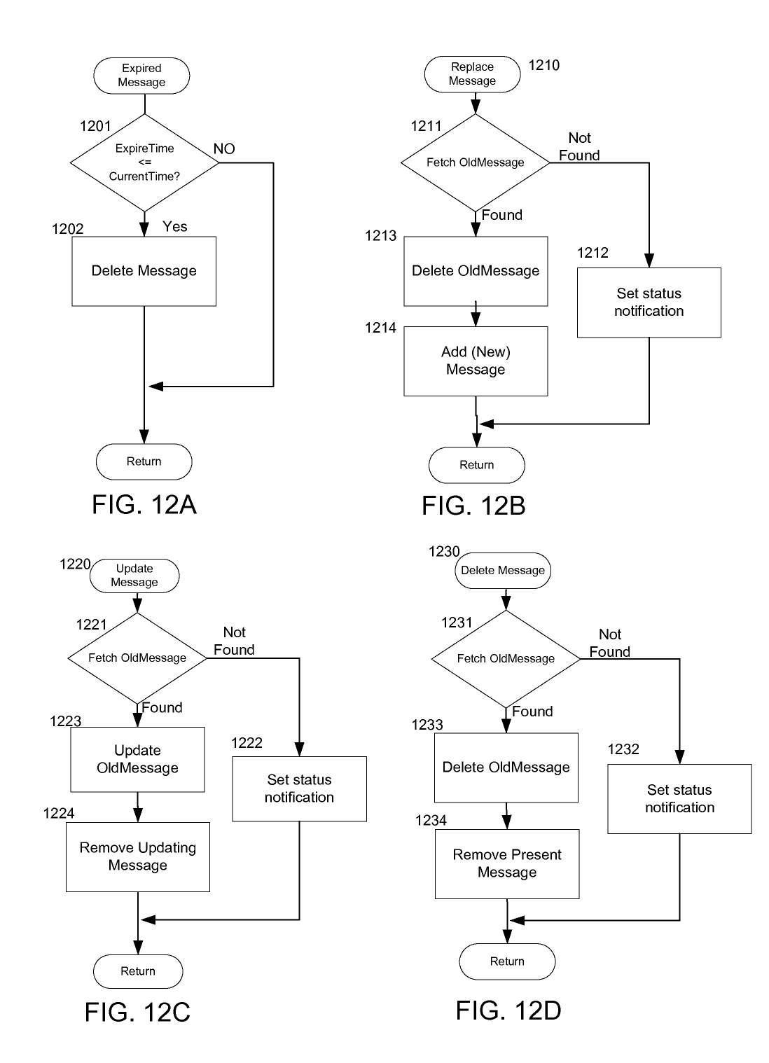

If it is appropriate to manage messages, the message processing application proceeds to determine whether there are any messages in the message store 13S to be managed (1103). There may be no messages to be managed if the message store 13S contains no messages. There may also be no message to be managed if none of the message metadata or message data indicates any managing actions to be performed, according to a set of rules. The rules may be dynamic. If there are no messages to be managed, the message processing application returns to determine when it is again appropriate to manage messages (1101). If there are a number of messages to be managed, the message processing application proceeds to access or obtain a message from the message store 13S (1104). Next, the message processing application manages the message (1105), as discussion further below with reference to FIG. 12, and sets an indication that the message has been managed. The process repeats until all messages to be managed are processed (1103-1105).

FIG. 12A is a flowchart illustrating the management of an expired message by the message processing application, according to embodiments of the present invention. Metadata or data of the message contains an expiration time for the message, such as in the form of a key-value pair stored with the message or in association with the message. In some implementations this expiration value is included with the message sent by the local server 114, or may be determined from a timestamp value of when the message is received by the receiver and from a set of rules; or by other means or a combination. The message processing application determines whether the message is expired by comparing the expiration time value of the message with the current time (1201). If the current time is not later than the expiration time, the message processing application does not delete the message. If the current time is later than the expiration time, the message processing application deletes the message from the message store 13S (1202).

FIG. 12B is a flowchart illustrating the replacement of the message by the message processing application, according to embodiments of the present invention. Here, the message processing application determines that a present (new) message indicates that an existing (old) message should be replaced by the present message (1210). In a number of implementations, data or metadata of the present message includes an identifier of the existing message, where the identifier may be simple or may be complex. The message processing application proceeds to fetch or access the existing message in the message store 13S, by providing the message identifier to the message store 13S (1211). If the existing message is not present in the message store 13S, for example if the existing message has been deleted by an operation of the message processing application or other operation, in a number of implementations the message manager 700 sets a status notification that the existing message was not present (1212). Alternately, the message processing application sets the status notification that the existing message was not present and also adds the new message (1214). If the existing message is found, the message processing application proceeds to delete the existing message from the message store 13S (1213). The message processing application then adds or retains the current message to the message store 13S as a replacement for the deleted or old message (1214).

FIG. 12C is a flowchart illustrating the update of the message by the message processing application, according to embodiments of the present invention. Here, the message processing application determines that an existing (old) message is to be updated with information of a present (new) message (1220). In a number of implementations, metadata or data of the present message includes an identifier of the existing message, and information to update, replace, or augment at least a portion of the information of the existing message. The message processing application proceeds to fetch or access the existing message in the message store 13S (1221), by providing the message identifier to the message store 13S. If the existing message is not present in the message store 13S, in a number of implementations the message processing application sets a status notification that the existing message was not present (1222). If the existing message is found, the message processing application proceeds to update the existing message using information of the present message (1223). The present message—referred to also as an updating message—is then removed from the message store (1224).

FIG. 12D is a flowchart illustrating the deletion of the message by the message processing application, according to embodiments of the present invention. In some applications, the deletion of a message may be referred to as recalling a message. As discussed above, the present message includes an identifier of the message to be deleted from the message store 13S. When the message processing application determines that the message is to be deleted (1230), the message processing application proceeds to fetch or access the existing message in the message store 13S, by providing the message identifier to the message store 13S (1231). If the existing message is not present in the message store 13S, in a number of implementations the message processing application sets a status notification that the existing message was not present (1232). If the existing message is found, the message processing application proceeds to delete the existing message from the message store (1233). The present message is also removed from the message store (1234).

FIGS. 12A-12D illustrate examples of actions for managing messages by the message processing application. Other actions for managing messages may be taken by the message processing application, or by the receiver itself, without departing from the spirit and scope of the present invention. Further, a message processing application as described above may run on a student computing device instead or in combination with the message processing application on the server or gateway.

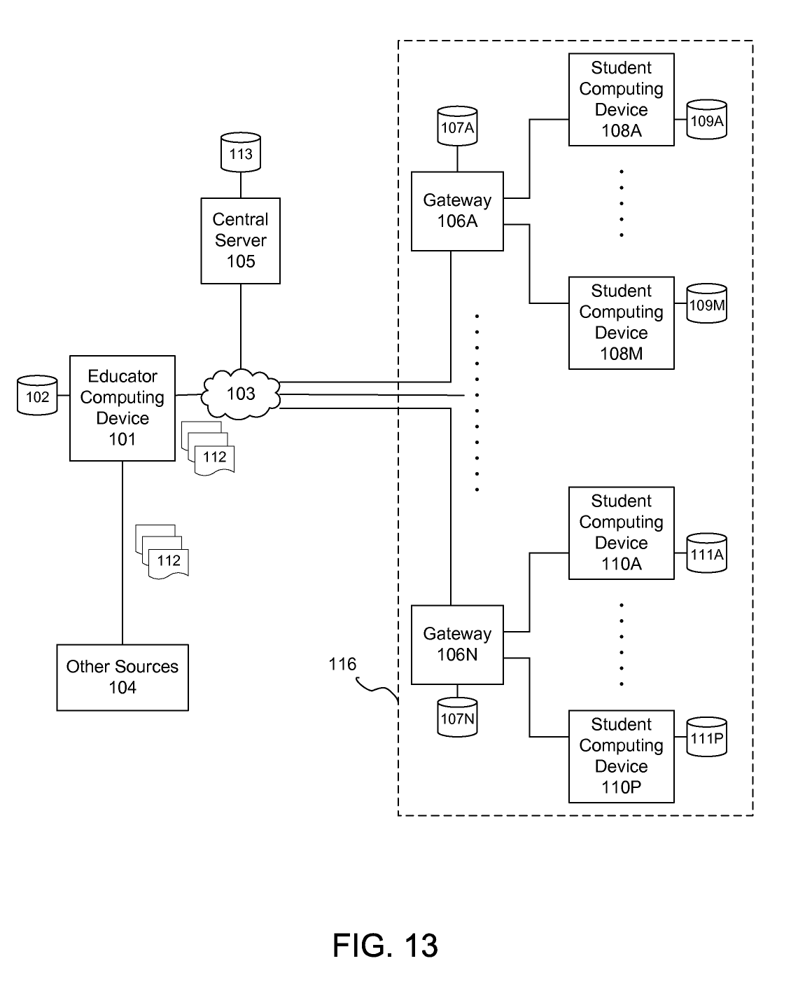

FIG. 13 is a functional block diagram illustrating an alternative network of components for the delivery of content in an education context according to embodiments of the present invention. The components of the network includes the same components as illustrated in FIG. 1 except instead of a connection between the central server 105 and the local servers 114 at the school locations, there are connections between the central server 105 and the gateway infrastructure at each school location via the Internet or WAN without an intermediate server. The central server 105 would perform the functions of both the central server 105 and each local server 114 as described above.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for delivery of content in an educational context, comprising:
(a) receiving, by a central server, one or more assignments from the one or more educator computing devices, wherein each assignment comprises content for distribution from one or more educator computing devices to a plurality of student computing devices and a schedule indicating when the assignment is active for distribution;
(b) receiving, by a local server within a school network, the one or more assignments and storing the assignments in a local server datastore;
(c) receiving, by the local server from a given gateway of a plurality of gateways within the school network, a request for active assignments stored in the local server datastore;
(d) identifying, by the local server, the active assignments stored in the local server datastore and returning a list of the active assignments stored in the local server datastore to the given gateway;
(e) determining, by the given gateway, whether the list of the active assignments stored in the local server datastore contains any assignments unretrieved by the given gateway;
(f) sending, by the given gateway to the local server, a request for the unretrieved assignments stored in the local server datastore; and
(g) receiving, by the given gateway, the requested assignments stored in the local server datastore from the local server and storing the requested assignments from the local server datastore in a given gateway datastore.

2. The method of claim 1, wherein the central server resides outside of the school network.

3. The method of claim 1, wherein the central server resides within the school network.

4. The method of claim 1, further comprising:
(h) connecting to the given gateway by a given student computing device within the school network;
(i) sending, by the given student computing device to the given gateway, a request for active assignments stored at the given gateway datastore;
(j) identifying, by the given gateway, the active assignments stored in the given gateway datastore and returning a list of the active assignments stored in the given gateway datastore to the given student computing device;
(k) determining, by the given student computing device, whether the list of the active assignments stored in the given gateway datastore contains any assignments unretrieved by the given student computing device;
(l) sending, by the given student computing device to the given gateway, a request for the unretrieved assignments stored in the given gateway datastore; and
(m) receiving, by the given student computing device, the requested assignments stored in the given gateway datastore from the given gateway and storing the requested assignments from the given gateway datastore in a given student computing device datastore.

5. The method of claim 4, wherein the list of the active assignments stored in the given gateway datastore comprises metadata for each active assignment, wherein the sending (l) comprise:
(l1) comparing the metadata for each unretrieved assignment with parameters stored at the given student computing device; and
(l2) sending, by the given student computing device to the given gateway, the request for the unretrieved assignments stored in the given gateway datastore with metadata matching the parameters.

6. The method of claim 1, further comprising:
(h) extracting, by the given gateway, a message comprising a given requested assignment and a first targeter,
wherein the given gateway comprises a second targeter,
wherein each targeter comprises one or more selectors associated with an action ID and one or more key value pairs;
(i) determining whether one or more conditions for a given selector are met for one or more values of the key value pairs; and
(j) in response to determining that the one or more conditions for the given selector are met, performing an action identified by the action ID associated with the given selector.

7. The method of claim 6, wherein the determining (i) and the performing (j) comprise:
(i1) using one or more values of the key value pairs of the second targeter, determining whether one or more conditions of a given selector of the first targeter are met; and
(j1) in response to determining that the one or more conditions of the given selector of the first targeter are met, performing an action for the action ID associated with the given selector of the first targeter.

8. The method of claim 6, wherein the determining (i) and the performing (j) comprise:
(i1) using one or more values of the key value pairs of the first targeter, determining whether one or more conditions of a given selector of the second targeter are met; and
(j1) in response to determining that the one or more conditions of the given selector of the second targeter are met, performing an action for the action ID associated with the given selector of the second targeter.

9. The method of claim 1, wherein each requested assignment comprises associated targeter data attributes, wherein the method further comprises:
(h) selecting, by the given gateway, one or more of the requested assignments from the local server for storage in the given gateway datastore based on the targeter data attributes associated with each requested assignment from the local server;
(i) receiving, by the given gateway, a message request from a receiver device within the school network; and
(j) in response to the message request, sending, by the given gateway, one or more assignments in the given gateway datastore to the receiver device.

10. A computer readable medium comprising computer readable program code embodied therein for delivery of content in an education context, wherein when executed by a processor causes the processor to:
(a) receive, by a central server, one or more assignments from the one or more educator computing devices, wherein each assignment comprises content for distribution from one or more educator computing devices to a plurality of student computing devices and a schedule indicating when the assignment is active for distribution;
(b) receive, by a local server within a school network, the one or more assignments and storing the assignments in a local server datastore;
(c) receive, by the local server from a given gateway of a plurality of gateways within the school network, a request for active assignments stored in the local server datastore;
(d) identify, by the local server, the active assignments stored in the local server datastore and returning a list of the active assignments stored in the local server datastore to the given gateway;
(e) determine, by the given gateway, whether the list of the active assignments stored in the local server datastore contains any assignments unretrieved by the given gateway;
(f) send, by the given gateway to the local server, a request for the unretrieved assignments stored in the local server datastore; and
(g) receive, by the given gateway, the requested assignments stored in the local server datastore from the local server and storing the requested assignments from the local server datastore in a given gateway datastore.

11. The medium of claim 10, further causing the processor to:
(h) connect to the given gateway by a given student computing device within the school network;
(i) send, by the given student computing device to the given gateway, a request for active assignments stored at the given gateway datastore;
(j) identify, by the given gateway, the active assignments stored in the given gateway datastore and returning a list of the active assignments stored in the given gateway datastore to the given student computing device;
(k) determine, by the given student computing device, whether the list of the active assignments stored in the given gateway datastore contains any assignments unretrieved by the given student computing device;
(l) send, by the given student computing device to the given gateway, a request for the unretrieved assignments stored in the given gateway datastore; and
(m) receive, by the given student computing device, the requested assignments stored in the given gateway datastore from the given gateway and storing the requested assignments from the given gateway datastore in a given student computing device datastore.

12. The medium of claim 11, wherein the list of the active assignments stored in the given gateway datastore comprises metadata for each active assignment, wherein the in the send (l), further causing the processor to:
(l1) compare the metadata for each unretrieved assignment with parameters stored at the given student computing device; and
(l2) send, by the given student computing device to the given gateway, the request for the unretrieved assignments stored in the given gateway datastore with metadata matching the parameters.

13. The medium of claim 10, further causing the processor to:
(h) extract, by the given gateway, a message comprising a given requested assignment and a first targeter,
wherein the given gateway comprises a second targeter,
wherein each targeter comprises one or more selectors associated with an action ID and one or more key value pairs;
(i) determine whether one or more conditions for a given selector are met for one or more values of the key value pairs; and
(j) in response to determining that the one or more conditions for the given selector are met, performing an action identified by the action ID associated with the given selector.

14. The medium of claim 13, wherein in the determine (i) and the perform (j), further causing the processor to:
(i1) using one or more values of the key value pairs of the second targeter, determine whether one or more conditions of a given selector of the first targeter are met; and
(j1) in response to determining that the one or more conditions of the given selector of the first targeter are met, perform an action for the action ID associated with the given selector of the first targeter.

15. The medium of claim 13, wherein in the determine (i) and the perform (j), further causing the processor to:
(i1) using one or more values of the key value pairs of the first targeter, determine whether one or more conditions of a given selector of the second targeter are met; and
(j1) in response to determining that the one or more conditions of the given selector of the second targeter are met, perform an action for the action ID associated with the given selector of the second targeter.

16. The medium of claim 10, wherein each requested assignment comprises associated targeter data attributes, further causing the processor to:
(h) select, by the given gateway, one or more of the requested assignments from the local server for storage in the given gateway datastore based on the targeter data attributes associated with each requested assignment from the local server;
(i) receive, by the given gateway, a message request from a receiver device within the school network; and
(j) in response to the message request, send, by the given gateway, one or more assignments in the given gateway datastore to the receiver device.

17. A system, comprising:
a central server outside of a school network for receiving one or more assignments from the one or more educator computing devices, wherein each assignment comprises content for distribution from one or more educator computing devices to a plurality of student computing devices and a schedule indicating when the assignment is active for distribution;
a local server within the school network for receiving the one or more assignments and storing the assignments in a local server datastore; and
a given gateway of a plurality of gateways within the school network,
wherein the local server receives from the given gateway a request for active assignments stored in the local server datastore,
wherein the local server identifies the active assignments stored in the local server datastore and returns a list of the active assignments stored in the local server datastore to the given gateway,
wherein the given gateway determines whether the list of the active assignments stored in the local server datastore contains any assignments unretrieved by the given gateway,
wherein the given gateway sends to the local server a request for the unretrieved assignments stored in the local server datastore, and
wherein the given gateway receives the requested assignments stored in the local server datastore from the local server and storing the requested assignments from the local server datastore in a given gateway datastore.

18. The system of claim 17, further comprising:
a given student computing device of a plurality of student computing devices within the school network connects to the given gateway,
wherein the given student computing device sends to the given gateway a request for active assignments stored at the given gateway datastore,
wherein the given gateway identifies the active assignments stored in the given gateway datastore and returns a list of the active assignments stored in the given gateway datastore to the given student computing device,
wherein the given student computing device determines whether the list of the active assignments stored in the given gateway datastore contains any assignments unretrieved by the given student computing device,
wherein the given student computing device sends to the given gateway a request for the unretrieved assignments stored in the given gateway datastore, and
wherein the given student computing device receives the requested assignments stored in the given gateway datastore from the given gateway and stores the requested assignments from the given gateway datastore in a given student computing device datastore.

19. The system of claim 17, wherein the given gateway further:
extracts a message comprising a given requested assignment and a first targeter, wherein the given gateway comprises a second targeter, wherein each targeter comprises one or more selectors associated with an action ID and one or more key value pairs;
determines whether one or more conditions for a given selector are met for one or more values of the key value pairs; and
in response to determining that the one or more conditions for the given selector are met, performs an action identified by the action ID associated with the given selector.

20. The system of claim 17, wherein each requested assignment comprises associated targeter data attributes, wherein the given gateway further:
selects one or more of the requested assignments from the local server for storage in the given gateway datastore based on the targeter data attributes associated with each requested assignment from the local server;
receives a message request from a receiver device within the school network; and
in response to the message request, sends one or more assignments in the given gateway datastore to the receiver device.
